(19) United States
(12) Patent Application Publication
(10) Pub. No.: US 2007/0208161 A1
(43) Pub. Date: Sep. 6, 2007

(54) Fibers formed of ester condensates and process for forming fibers from ester condensates

(76) Inventors: Isao Noda, Fairfield, OH (US); William Maxwell Allen, Liberty Twp., OH (US); James Terry Knapmeyer, Rossmoyne, OH (US); Michael Matthew Satkowski, Oxford, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/712,538

(22) Filed: Feb. 28, 2007

Related U.S. Application Data
(60) Provisional application No. 60/777,759, filed on Mar. 1, 2006.

(51) Int. Cl. C08G 63/02

(52) U.S. Cl. 528/272

(57) ABSTRACT

Fibers are formed from ester condensates of polyhydric alcohols and organic polyacids or anhydrides. The process for making the fibers comprises forming a reactive mixture from a polyhydric alcohol and organic polyacid mixture heated to produce a low molecular weight ester condensation product which is subsequently pumped through a spinneret causing additional ester condensation reaction in situ with fiber formation.

### CROSS REFERENCE TO RELATED APPLICATION

This application claims the benefit of provisional Application No. 60/777,759, filed Mar. 1, 2006.

### FIELD OF THE INVENTION

The present invention is directed to fibers produced by in situ condensation reaction during the fiber spinning process of a mixture of low molecular weight materials. In a specific embodiment, the present invention relates to fibers formed from ester condensates of polyhydric alcohol and organic polyacid.

### BACKGROUND OF THE INVENTION

Nonwovens have traditionally been manufactured from synthetic fibers comprising thermoplastic resins. Although it is unusual to find examples of spinning fibers using thermosetting resins, lately there has been some interest in the use of thermosetting resins for fiber making, especially in the area of melt blown nonwovens. Thermoset resins provide a starting material having a low viscosity suitable for fabricating superfine fibers for nonwovens.

Some common thermoset resins include phenol formaldehyde, urea formaldehyde and epoxy. Disadvantages associated with these types of thermoset resins for fiber making include the release of undesirable and often toxic fumes; minimal control of solidification during fiber formation, and the fact that the cross linking reactions for thermoset resins are typically not reversible.

Thermoplastic and thermoset resins are typically derived from petroleum based feedstock. The rising cost of petroleum has prompted the need for alternative robust, low cost materials for producing synthetic fibers and corresponding nonwovens manufactured therefrom.

Alkyd is a term applied to a group of synthetic thermoset resins best described as oil-modified polyester resins. This group of material comprises ester condensates of polyhydric alcohols and organic polyacids. Glycerin is the predominant polyhydric alcohol component used in ester condensates. An increasing supply of glycerin has prompted the opportunity for developing a process for forming synthetic fibers from ester condensate resins.

### SUMMARY OF THE INVENTION

The present invention provides fibers comprising ester condensation products formed from reactive mixtures comprising a monomer mixture having at least one polyhydric alcohol and a reactant selected from the group consisting of at least one organic polyacid; at least one organic anhydride; and combinations thereof. Alternatively, the reactive mixture comprises a prepolymer formed from the monomer mixture; a combination of the prepolymer and the monomer mixture; or a combination of the prepolymer and reactants such as polyhydric alcohol, organic polyacid, organic anhydride, and combinations thereof.

The invention is also directed to a process for making fibers from ester condensation products. The process comprises heating the aforementioned reactive mixtures under pressure and pumping the mixtures through a spinneret forming fibers.

In addition, the invention is directed to a fiber forming composition comprising the aforementioned reactive mixtures and fiber forming process aids. The fiber forming process aids include polymers (such as polyesters and polyamides), surfactants and oils.

### DETAILED DESCRIPTION

All percentages, ratios and proportions used herein are by weight percent of the reactive mixture, unless otherwise specified. All average values are calculated “by weight” of the reactive mixture or components thereof, unless otherwise expressly indicated. “Average molecular weight,” or “molecular weight” for polymers, unless otherwise indicated, refers to weight average molecular weight. Weight average molecular weight, unless otherwise specified, is determined by gel permeation chromatography.

“Copolymer” as used herein is meant to encompass copolymers, terpolymers, and other multiple-monomer polymers.

“Reactive” as used herein refers to a chemical substance that is present at the start of a chemical reaction and reacts with one or more other substances or catalysts in or exposed as part of a chemical reaction.

“Mixture” as used herein refers to a mixture of two or more of any of a defined group of components, unless otherwise specified. Lists of alternative ingredients include mixtures of such ingredients unless otherwise specified.

“Biodegradable” as used herein refers to the ability of a compound to ultimately be degraded completely into CH₄, CO₂ and water or biomass by microorganisms and/or natural environmental factors.

“Compostable” as used herein refers to a material that meets the following three requirements: (1) the material is capable of being processed in a composting facility for solid waste; (2) if so processed, the material will end up in the final compost; and (3) if the compost is used in the soil, the material will ultimately biodegrade in the soil.

“Comprising” as used herein means that various components, ingredients or steps can be conjointly employed in practicing the present invention. Accordingly, the term “comprising” encompasses the more restrictive terms “consisting essentially of” and “consisting of”. The present reactive compositions can comprise, consist essentially of, or consist of any of the required and optional elements disclosed herein.

Markush language as used herein encompasses combinations of the individual Markush group members, unless otherwise indicated.

Regarding all numerical ranges disclosed herein, it should be understood that every maximum numerical limitation given throughout this specification includes every lower numerical limitation, as if such lower numerical limitations were expressly written herein. In addition, every minimum numerical limitation given throughout this specification will include every higher numerical limitation, as if such higher numerical limitations were expressly written herein. Further, every numerical range given throughout this specification will include every narrower numerical range that falls within such broader numerical range and will also encompass each individual number within the numerical range, as if such narrower numerical ranges and individual numbers were all expressly written herein.

The present compositions, products and processes employ fibers formed of ester condensates of biorenewal materials which provide promising alternatives to petroleum based feedstock. The invention is also directed to prepolymers comprising intermediate ester condensates of polyhydric alcohol and organic polyacid having a low viscosity. The prepolymers can be processed to provide additional ester condensation reaction forming crosslinked polymer fibers.

Conventional melt spinning of thermoplastics involves the extrusion of high viscosity molten polymers. The spinning process of the present invention takes advantage of a low viscosity reaction mixture, which can be readily pumped through a spinneret without the aid of a high power extruder, providing a reaction-induced condensation reaction to form the desired fibers. The low viscosity of the raw material during the spinning process is especially advantageous to produce very fine diameter fibers desirable for high opacity, softness, and strength. For the present invention, the viscosity of the reactive mixture can be less than about 1000 poise, less than about 500 poise, less than about 200 poise, and less than about 100 poise.

Unlike polyolefin based thermoplastic fibers, the fibers produced according to the present invention are made of the condensation product of alcohol and acids and enjoy the advantageous properties of polyesters, such as high surface energy and wettability. As a result of cross linking, the fibers produced are thermoset, exhibiting a high level of dimensional stability even under elevated temperature. The fiber materials are also expected to be environmentally degradable by spontaneous hydrolysis or biodegradation. Acid- or base-catalyzed chemical digestion, especially with elevated temperature in the presence of water, is also expected.

A reaction mixture of low molecular weight materials as described hereunder can be directly heated and spun into fibers. More preferred method, however, is to form intermediate condensates referred to as a prepolymer reaction product. The resulting prepolymer reaction product is then used for fiber spinning. The term “prepolymer reaction product” or “prepolymer” refers to the reaction product of the polyhydric alcohol and organic polyacid having a suitable viscosity for processing to form fibers at the selected fiber spinning temperature and processing conditions. Those skilled in the art will recognize that prepolymer may include any condensate reaction products including, but not limited to, compounds, oligomers, and polymers.

For instance, fibers useful especially for making nonwoven webs are produced from a reactive mixture comprising polyhydric alcohol (preferably glycerol) and organic polyacid or anhydride. The reaction mixture is spun at a sufficiently elevated temperature to induce an ester forming condensation reaction (commonly known as alkyd chemistry) which polymerize and crosslink the mixture during the spinning process by liberating water as a reaction byproduct after the mixture leaves the spinneret to open atmosphere. Optionally, a prepolymer comprising an intermediate condensate mixture comprising polyhydric alcohol with organic polyacid or anhydride can be formed separately and later spun at a sufficiently elevated temperature to induce the ester forming condensation reaction. For this embodiment, the prepolymer can be provided in a form which facilitates handling, further processing, or the like.

The solidification of the reactive mixtures into fibers is facilitated by the progress of ester condensation reaction to produce high molecular weight polyesters, often highly crosslinked to form insoluble and infusible fibers, by liberating water as a reaction byproduct. This reaction is accelerated by the elevated temperature and evaporation or removal of the water. Alternatively, the reaction can be controlled or limited by controlling the amount of polyacid, the degree of functionalization of the polyacids, or by limiting the removal or evaporization of water during the reaction, which if not removed from the system effectively stops the condensation reaction. Thus, a key parameter is the reactive mixture temperature selected for the spinning process. The reaction mixture temperature may be between about 100° C. and about 300° C., between about 120° C. and about 280° C., or between about 150° C. and about 260° C. Esterification catalysis, such as Lewis acids and certain metal salts, can also be used to accelerate the reaction.

### Polyhydric Alcohol

One or more polyhydric alcohols are used in the reactive mixture of the present invention.

“Polyhydric alcohol” as used herein refers to an alcohol having two or more alcohol (i.e., hydroxyl) functional groups. Any suitable polyhydric alcohol or combination of polyhydric alcohols is of use; however, monomers, oligomers, or short chain polymer polyhydric alcohols having a molecular weight of less than 2000 g/mol are preferred. Non-limiting examples of suitable polyhydric alcohols include: glycerol (also known in the art as glycerin), glycol, sugar, sugar alcohol, and combinations thereof. Non-limiting examples of glycols of use include: ethylene glycol, propylene glycol, dipropylene glycol, butylene glycol, hexane triol, and the like, oligomers thereof, and combinations thereof. Non-limiting examples of sugars of use include: glucose, sucrose, fructose, raffinose, maltodextrose, galactose, xylose, maltose, lactose, mannose, erythrose, pentaerythritol, and mixtures thereof. Non-limiting examples of sugar alcohols of use include: erythritol, xylitol, malitol, mannitol, sorbitol, and mixtures thereof. In specific embodiments of the present invention, the polyhydric alcohol comprises glycerol, mannitol, sorbitol, and combinations thereof.

Typically, the polyhydric alcohol can be present in reactive mixtures of the present invention in an amount of from about 10% to about 90%, and more specifically, from about 20% to about 80%, and still more specifically from about 30% to about 70% by weight of the mixture.

### Organic Polyacid and Anhydrides

The reactive mixture used in forming fibers according to the present invention includes organic polyacids and anhydrides. The organic polyacid means an organic acid having two or more acid functionalities and can include, but is not limited to, diacids, triacids (having at least three acid groups), other acids with four or more acid functionalities, acid polymers or copolymers, or mixtures thereof. Such acids include, but are not limited to adipic acid, sebatic acid, citric acid, oxalic acid, malonic acid, succinic acid, glutaric acid, maleic acid, fumaric acid, phthalic acid, isophthalic acid, terphthalic acid, and mixtures of two or more thereof. Anhydrides of such acids may also be employed and within the context of the present specification, reference to organic polyacid includes such anhydrides. Monoacids such as lauric acid, stearic acid, myristic acid, palmitic acid, oleic acid, linoleic acid, sebacic acid, acrylic acid, methacrylic acid, itaconic acid, and glycidyl methacrylate may optionally be included in addition to polyacids at any stage. For example, monoacids may be added as processing aids or to modify properties of the final product, e.g. flexibility, strength, etc.

For the present invention many different types of organic polyacids and anhydrides can be used including adipic acid, citric acid, maleic acid, maleic anhydride, polyacrylic acid, phthalic anhydride, and the like, as well as their mixtures. Monobasic acids, especially fatty acids like stearic acid, lauric acid, oleic acid, and linoleic acid, can also be incorporated into the reaction mixture. Other functional compounds with reactive acid or alcohol functionality, such as oligomeric silicone or polyethylene glycol, may also be incorporated.

Typically, the organic polyacid is employed in a mixture for forming the reactive mixture composition in an amount of from about 10% to about 90%, and more specifically, from about 20% to about 80%, and still more specifically from about 30% to about 70% by weight of the mixture.

### Triglyceride

Any suitable triglycerides, which are also known in the art as triacylglycerols, may also be included in the reactive mixture. Non-limiting examples of triglycerides of use include: tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin and combinations thereof.

Suitable triglycerides may be added to the present reactive compositions in neat form. Additionally, or alternatively, oils and/or processed oils containing suitable triglycerides may be added to the reactive compositions. Non-limiting examples of oils include coconut oil, corn germ oil, olive oil, palm seed oil, cottonseed oil, palm oil, rapeseed oil, sunflower oil, whale oil, soybean oil, peanut oil, linseed oil, tall oil, and combinations thereof.

Typically, triglycerides are employed in the reactive mixture in an amount up to about 75%, or from about 2% to about 50%, or from about 5% to about 25%.

In some embodiments, combinations of acid and triglyceride are employed in the reactive mixture. In such embodiments, the total amounts of acid and triglyceride is from about 20% to about 80%, from about 30% to about 70%, or from about 40% to about 60%. Additionally, or alternatively, the molar ratio of the alcohol functional groups to the total of ester and acid functional groups is at least about 1:1, or at least about 4:1. In some embodiments, the molar ratio is from about 1:1 to about 200:1, or from about 1:1 to about 50:1.

The reactive mixture of the present invention may also include monobasic acid, and appropriate amounts of monoglyceride, or diglyceride as alternatives to triglyceride.

The reactive mixture or prepolymer compositions according to the invention may include one or more additional components as desired for the processing and/or end use of the composition. For example, the compositions may comprise one or more additional polymers, for example, polyvinyl alcohol and polyhydric alcohols having molecular weights of greater than 2000 g/mol or one or more additional processing aids or the like, in amounts conventional in the art.

In addition, it is possible to add any of the reactants or other additives described hereunder to the original reactive mixtures or prepolymers before spinning. A spinning process aid, such as a small amount (i.e., less than 5 wt %) of thermoplastic polymers, such as polycaprolactone and poly(ethylene terephthalate) may be added to improve the spinnability of the mixture. Other obvious additives include antiblocking agents, such as magnesium stearates and slip agents, like behenamides, as well as antioxidants, colorants, and the like.

Forming a prepolymer prior to processing the mixture through the spinneret has the advantage that it can be used to carry the condensation reaction to nearer completion, allowing for some of the water formed from the condensation reaction to be removed before the spinning step. This may facilitate the final spinning step where the reaction is further driven. When preparing a prepolymer prior to fiber spinning, the reaction should not continue beyond the point where the viscosity is too high from a practical standpoint to pump the prepolymer reaction product through a spinneret for fiber formation. As previously discussed, viscosity of the prepolymer reaction product (including any additional ingredients that may be included) can in general be within the viscosity limits discussed above.

Furthermore, additional components may be added to the condensation reaction products and/or the prepolymer mixture, before and/after the initial ester condensates are formed, but before final spinning. Such components include but are not limited to processing aids, plasticizers, and other polymers and components to modify properties of the fibers. Such additional components can include, but are not limited to, monoacids, as elsewhere described in this specification.

Additionally, two or more different organic polyacids may be used in making the fibers of the present invention. These can include combinations of polyacids having different degrees of acid functionality. For example diacids can be used in combination with triacids and/or other polyacids. Further, two or more different polyacids can be used at different stages of the process. For example, one or more acids may be used to make the prepolymer, whereas a different polyacid or combination of polyacids may be used in the final spinning step of the process. In another embodiment, the same polyacid or combination of polyacids are used at both stages of the process wherein an additional amount of such polyacid (or combination of polyacids) are added at the later stage, prior to spinning, in order to accelerate or drive the reaction toward completion. In one embodiment, diacids are used during prepolymer formation and either additional diacids, polyacids with three (3) or more acid functionalities, or embodiment thereof are included in the mixture during fiber spinning. If using polyacids with three (3) or more acid functionalities during prepolymer formation, it may be desirable to limit the reaction so as to avoid having the reaction progress beyond the point that the prepolymer viscosity is too high for it to be effectively pumped through the spinneret for fiber formation. Factors and steps to control this reaction are well known to those skilled in the art and include, but are not limited to limiting the amount of polyacids used (especially limiting the proportion or amount of polyacid with three or more acid functionalities), temperature (higher temperature increases reaction rate), reaction time, and limiting the evaporation or removal of water (for example by conducting the reaction in a closed or pressurized system). An example of such a process would be to react maleic anhydride and glycerol to an extent that a low viscosity prepolymer is formed, then before spinning, polycyclic acid or alternatively citric acid could be introduced. These polyamides with functionality greater than two would act to increase cross linking in the system as the fibers are formed. This in turn could result in faster solidification of the fibers.

Optionally, other ingredients may be incorporated into the spinnable prepolymer. These optional ingredients may be present in quantities of less than about 50%, preferably from about 0.1% to about 20%, and more preferably from about 0.1% to about 12% by weight of the composition. The optional materials may be used to modify the processability and/or to modify physical properties such as elasticity, tensile strength and modulus of the final product. Other benefits include, but are not limited to, stability including oxidative stability, brightness, color, flexibility, resiliency, workability, processing aids, viscosity modifiers, and odor control. Nonlimiting examples include salts, slip agents, odor masking agents, cross-linking agents, emulsifiers, surfactants, cyclodextrins, lubricants, other processing aids, optical brighteners, antioxidants, flame retardants, dyes, pigments, fillers, proteins and their alkali salts, waxes, tackifying resins, extenders, and mixtures thereof.

Other additives are typically included as a processing aid and to modify physical properties such as elasticity, dry tensile strength, and wet strength of the fibers. Suitable extenders for use herein include gelatin, vegetable proteins such as sunflower protein, soybean proteins, cotton seed proteins, and water soluble polysaccharides; such as alginates, carrageenans, guar gum, agar, gum arabic and related gums, pectin, water soluble derivatives of cellulose, such as alkylcelluloses, hydroxyalkylcelluloses, and carboxymethylcellulose. Also, water soluble synthetic polymers, such as polyacrylic acids, polyacrylic acid esters, polyvinylacetates, polyvinylalcohols, and polyvinylpyrrolidone, may be used.

Lubricant compounds may further be added to improve the flow properties of the material during the processes used for producing the present invention. The lubricant compounds can include animal or vegetable fats, preferably in their hydrogenated form, especially those which are solid at room temperature. Additional lubricant materials include mono-glycerides and di-glycerides and phosphatides, especially lecithin. For the present invention, a preferred lubricant compound includes the mono-glyceride, glycerol mono-stearate.

Further additives including inorganic fillers such as the oxides of magnesium, aluminum, silicon, and titanium may be added as inexpensive fillers or processing aides. Other inorganic materials include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, phosphate salts, may be used as processing aides. Other optional materials that modify the water responsiveness of the fiber are stearate based salts, such as sodium, magnesium, calcium, and other stearates and rosin components including anchor gum rosin. Another material that can be added is a chemical composition formulated to further accelerate the environmental degradation process such as colbalt stearate, citric acid, calcium oxide, and other chemical compositions found in U.S. Pat. No. 5,854,304 to Garcia et al.

Spinning of the reaction mixture can be carried out by any of the various methods used in conventional fiber spinning, including that employing a high speed air jet to elongate the fiber-forming materials. Depending on the configuration of such spinning devices, fibers with normal diameters, as well as ultra fine micro and nano fibers may be spun.

In general, high fiber spinning rates are desired. Fiber spinning speeds of about 10 meters/minute or greater can be used. In some embodiments hereof, the fiber spinning speed is from about 100 to about 7,000 meters/minute, or from about 300 to about 3,000 meters/minute, or from about 500 to about 2,000 meters/minute. The spun fibers can be collected using conventional godet winding systems or through air drag attenuation devices. The fibers may be crimped and/or cut to form non-continuous fibers (staple fibers) used in a carding, airlaid, or fluidlaid process. Continuous fibers can be produced through, for example, spunbond methods or meltblowing processes. Alternately, non-continuous (staple fibers) fibers can be produced according to conventional staple fiber processes as are well known in the art. The various methods of fiber manufacturing can also be combined to produce a combination technique, as will be understood by those skilled in the art. Additionally, hollow core fibers as disclosed in U.S. Pat. No. 6,368,990 can be formed.

Typically, the diameter of fibers produced according to the present invention is less than about 200 microns, and in alternate embodiments is less than about 100 microns, less than about 50 microns, or less than about 30 microns. In one embodiment, the fibers have a diameter of from about 0.1 microns to about 25 microns. In another embodiment the fibers may have a diameter from about 0.2 microns to about 15 microns. In other embodiment, the fibers may have a diameter from about 5 microns to about 14 microns. Fiber diameter is controlled by factors well known in the fiber spinning art including, for example, spinning speed and mass through-put.

The fibers hereof may be used for any purposes for which fibers are conventionally used. This includes, without limitation, incorporation into nonwoven or woven webs and substrates. The fibers hereof may be converted to nonwovens by any suitable methods known in the art. Continuous fibers can be formed into a web using industry standard spunbond type technologies while staple fibers can be formed into a web using industry standard carding, airlaid, or wetlaid technologies. Typical bonding methods include: calendar (pressure and heat), thru-air heat, mechanical entanglement, hydrodynamic entanglement, needle punching, and chemical bonding and/or resin bonding. The calendar, thru-air heat, and chemical bonding are the preferred bonding methods for the ester condensate and polymer multicomponent fibers. Thermally bondable fibers are required for the pressurized heat and thru-air heat bonding methods.

The fibers of the present invention may comprise multiconstituent fibers in many different configurations. Constituent, as used herein, is defined as meaning the chemical species of matter or the material. Fibers may be of monocomponent or multicomponent in configuration. Component, as used herein, is defined as a separate part of the fiber that has a spatial relationship to another part of the fiber.

Multiconstituent fibers include blends with other polymers including natural and synthetic polymers and biodegradable and non biodegradable polymers. Nonlimiting examples of biodegradable thermoplastic polymers suitable for use in the present invention include aliphatic polyesteramides; diacids/diols aliphatic polyesters; modified aromatic polyesters including modified polyethylene terephtalates, modified polybutylene terephtalates; aliphatic/aromatic copolyesters; polycaprolactones; poly(3-hydroxyalkanoates) including poly(3-hydroxybutyrates), poly(3-hydroxyhexanoates, and poly(3-hydroxyvalerates); poly(3-hydroxyalkanoates) copolymers, poly(hydroxybutyrate-co-hydroxyvalerate), poly(hydroxybutyrate-co-hexanoate) or other higher poly(hydroxybutyrate-co-alkanoates) as references in U.S. Pat. No. 5,498,692 to Noda, herein incorporated by reference; polyesters and polyurethanes derived from aliphatic polyols (i.e., dialkanoyl polymers); polyamides including polyethylene/vinyl alcohol copolymers; lactic acid polymers including lactic acid homopolymers and lactic acid copolymers; lactide polymers including lactide homopolymers and lactide copolymers; glycolide polymers including glycolide homopolymers and glycolide copolymers; and mixtures thereof. Preferred are aliphatic polyesteramides, diacids/diols aliphatic polyesters, aliphatic/aromatic copolyesters, lactic acid polymers, and lactide polymers.

Spunbond structures, staple fibers, hollow fibers, shaped fibers, such as multi-lobal fibers and multicomponent fibers may all be produced by using the compositions and methods of the present invention. Multicomponent fibers, commonly a bicomponent fiber, may be in a side-by-side, sheath-core, segmented pie, ribbon, or islands-in-the-sea configuration. The sheath may be continuous or non-continuous around the core. The ratio of the weight of the sheath to the core is from about 5:95 to about 95:5. The fibers of the present invention may have different geometries that include round, elliptical, star shaped, rectangular, and other various eccentricities. The fibers of the present invention may also be splittable fibers. Splitting may occur by rheological differences in the polymers or splitting may occur by a mechanical means and/or by fluid induced distortion.

For a bicomponent, the ester condensate/polymer composition of the present invention may be both the sheath and the core with one of the components containing more ester condensate or polymer than the other component. Alternatively, the ester condensate/polymer composition of the present invention may be the sheath with the core being pure polymer or ester condensate. The ester condensate/polymer composition could also be the core with the sheath being pure polymer or ester condensate. The exact configuration of the fiber desired is dependent upon the use of the fiber.

The fibers of the present invention may also be bonded or combined with other synthetic or natural fibers to make nonwoven articles. The synthetic or natural fibers may be blended together in the forming process or used in discrete layers. Suitable synthetic fibers include fibers made from polypropylene, polyethylene, polyester, polyacrylates, and copolymers thereof and mixtures thereof. Natural fibers include cellulosic fibers and derivatives thereof. Suitable cellulosic fibers include those derived from any tree or vegetation, including hardwood fibers, softwood fibers, hemp, and cotton. Also included are fibers made from processed natural cellulosic resources such as rayon.

The fibers described herein are typically used to make disposable nonwoven materials for use in articles which may find applications in one of many different uses. Specific articles of the present invention include disposable nonwovens for hygiene and medical applications, more specifically, for example, in applications such as diapers, wipes, feminine hygiene articles, drapes, gowns, sheeting, bandages and the like. In diapers, nonwoven materials are often employed in the top sheet or back sheet, and in feminine pads or products, nonwoven materials are often employed in the top sheet. Nonwoven articles generally contain greater than about 15% of a plurality of fibers that are continuous or non-continuous and physically and/or chemically attached to one another. The nonwoven may be combined with additional nonwovens or films to produce a layered product used either by itself or as a component in a complex combination of other materials. Nonwoven products produced from fibers can also exhibit desirable mechanical properties, particularly, strength, flexibility and softness. Measures of strength include dry and/or wet tensile strength. Flexibility is related to stiffness and can attribute to softness. Softness is generally described as a physiologically perceived attribute which is related to both flexibility and texture. One skilled in the art will appreciate that the fibers according to the invention are also suitable for use in applications other than nonwoven articles.

Notwithstanding the water stability of the fibers and other products produced in the present invention, the products may be environmentally degradable depending upon the amount of any additional polymer used, and the specific configuration of the product. “Environmentally degradable” is defined as being biodegradable, disintegratable, dispersible, flushable, or compostable or a combination thereof. In the present invention, the fibers, nonwoven webs, and articles may be environmentally degradable.

### EXAMPLE

In an exemplary embodiment of the present invention, a 1:1 mole ratio reaction mixture of glycerol and maleic anhydride is formed comprising a 50 g test batch comprising 25.8 g maleic anhydride and 24.2 g of glycerol. The reaction mixture is first heated in an open kettle at about 160° C. to produce a prepolymer with low viscosity (prepolymer mixture). The pre-polymer mixture is then heated in a closed vessel at a higher temperature (about 260° C.) and pumped through a spinneret into atmospheric pressure environment, where the additional ester condensation reaction takes place in situ during the fiber formation by liberating more water, leading eventually to the gelation and cross linking of fibers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fiber comprising an ester condensation product formed from a reactive mixture selected from the group consisting of:
(a) a monomer mixture comprising at least one polyhydric alcohol and reactant selected from the group consisting of: at least one organic polyacid; at least one organic anhydride; and combinations thereof;
(b) prepolymer formed from the monomer mixture according to (a);
(c) combinations of the monomer mixture in (a) and the prepolymer in (b); and
(d) combinations of the prepolymer in (b) and reactants selected from the group consisting of: polyhydric alcohol; organic polyacid; organic anhydride; and combinations thereof.

2. The fiber according to claim 1, wherein the polyhydric alcohol is selected from the group consisting of glycerol, glycol and combinations thereof.

3. The fiber according to claim 1, wherein the organic polyacid is selected from the group consisting of adipic acid, citric acid, maleic acid, polyacrylic acid and combinations thereof.

4. The fiber according to claim 1, wherein the anhydride is selected from the group consisting of maleic anhydride, phthalic anhydride and combinations thereof.

5. The fiber according to claim 1, wherein the reactive mixture further comprises monobasic acid, monoglyceride, diglyceride, or triglyceride.

6. The fiber according to claim 1, wherein the reactive mixture further comprises compounds having functional groups selected from the group consisting of acid groups, alcohol groups and combinations thereof, and further wherein the compounds are selected from the group consisting of oligomeric silicone, polyethylene glycol and combinations thereof.

7. The fiber according to claim 1, wherein the fibers are degradable by hydrolysis or biodegradation.

8. A nonwoven fabric comprising fibers according to claim 1.

9. A disposable article comprising the nonwoven fabric of claim 8.

10. A process for making fibers comprising the steps of:
a) providing a composition comprising a reactive mixture selected from the group consisting of:
1) a monomer mixture comprising at least one polyhydric alcohol and a reactant selected from the group consisting of: at least one organic polyacid; at least one organic anhydride; and combinations thereof;
2) prepolymer formed from the monomer mixture according to (1);
3) combinations of the monomer mixture in (1) and the prepolymer in (2); and
4) combinations of the prepolymer in (2) and reactants selected from the group consisting of: polyhydric alcohol; organic polyacid; organic anhydride; and combinations thereof; and
b) pumping the composition through a spinneret at elevated temperature to form fibers.

11. The process according to claim 10, wherein the polyhydric alcohol is selected from the group consisting of glycerol, glycol and combinations thereof.

12. The process according to claim 10, wherein the organic polyacid is selected from the group consisting of adipic acid, citric acid, maleic acid, succinic acid, polyacrylic acid and combinations thereof.

13. The process according to claim 10, wherein the anhydride is selected from the group consisting of succinic anhydride, maleic anhydride, phthalic anhydride and combinations thereof.

14. The process according to claim 10, wherein the reactive mixture further comprises monobasic acid, monoglyceride, diglyceride, or triglyceride.

15. The process according to claim 10, wherein the reactive mixture further comprises compounds having functional groups selected from the group consisting of acid groups, alcohol groups and combinations thereof, and further wherein the compounds are selected from the group consisting of oligomeric silicone, polyethylene glycol and combinations thereof.

16. A fiber forming composition comprising:
(1) a reactive mixture selected from the group consisting of:
(a) a monomer mixture comprising at least one polyhydric alcohol and a reactant selected from the group consisting of: at least one organic polyacid; at least one organic anhydride; and combinations thereof;
(b) prepolymer formed from the monomer mixture according to (a);
(c) combinations of the monomer mixture in (a) and the prepolymer in (b); and
(d) combinations of the prepolymer in (b) and reactants selected from the group consisting of: polyhydric alcohol; organic polyacid; organic anhydride; and combinations thereof; and
(2) fiber forming process aids.

17. The fiber forming composition according to claim 16 wherein the fiber forming process aids include polymers, surfactants and oils.

18. The fiber forming composition according to claim 17 wherein the polymers are polyesters selected from the group consisting of polyethylene, terphthalate, and polycaprolactone.

19. The fiber forming composition according to claim 17 wherein the polymers comprise polyamides.

20. The fiber forming composition according to claim 17 wherein the polymers comprise polyvinyl alcohol.
